(19) United States
(12) Patent Application Publication
(10) Pub. No.: US 2007/0297009 A1
(43) Pub. Date: Dec. 27, 2007

(54) PRINT DATA GENERATING APPARATUS, PRINT DATA GENERATING METHOD, AND COMPUTER-EXECUTABLE PROGRAM

(75) Inventor: Koji Kikuchi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/765,162

(22) Filed: Jun. 19, 2007

(30) Foreign Application Priority Data
Jun. 23, 2006 (JP) 2006-174459

(51) Int. Cl. G06K 15/00

(52) U.S. Cl. 358/1.18

(57) ABSTRACT

An apparatus generates print data based on a print form having a plurality of field areas defined therein into which data can be inserted and outputs the print data to a printing apparatus. The apparatus receives a setting of a condition concerning changing of a layout of at least one field area defined in the print form, changes a layout of the at least one field area according to the received condition, and generates print data based on the print form having the changed layout of the at least one field area.

### BACKGROUND OF THE INVENTION

1. Field of the Invention

The present invention relates to a print data generating apparatus, a print data generating method, and a computer-executable program. More particularly, the present invention relates to a print data generating apparatus, a print data generating method, and a computer-executable program, which are adapted to generate print data based on a print form having a plurality of field areas defined therein into which data can be inserted.

2. Description of the Related Art

In recent years, a printing method has been proposed in which data can be inserted into a print form, such as a form template. The form template includes one or a plurality of fields into which data can be inserted. The position and size of each field are defined on a page-by-page basis. Since such form templates are treated as resources, various form templates are generally prepared for various applications. Thus, the form templates grow in number each time their layout is changed according to, for example, revision. Accordingly, the management and use of form templates may become complicated, thus resulting in higher management cost.

Under such circumstances, it may be necessary to reduce the number of form templates to be managed. Japanese Patent Application Laid-Open No. 2005-216174 discusses a method for making the size of a field defined in a form template variable such that the size of a field is automatically reduced or enlarged according to the amount of data to be inserted into the field. Further, it also discusses a method for calculating sizes of respective adjacent fields and changing the position of a field according to the calculated sizes.

Japanese Patent Application Laid-Open No. 8-80643 discusses a method for preparing form pages respectively provided for an even page and an odd page and automatically selecting an appropriate form page by determining whether a page to be output is an even page or an odd page.

In the method for changing the size of a field of a form template according to the amount of data to be inserted into the field, as discussed in Japanese Patent Application Laid-Open No. 2005-216174, the size of the field depends on the amount of data to be inserted into the field. Therefore, a field defined in a form template can be changed only by changing the amount of data to be inserted into the field. Accordingly, it is difficult to change the layout of some fields in a form template or to shift their positions.

In the method discussed in Japanese Patent Application Laid-Open No. 8-80643, although different form pages can be used between an even page and an odd page, it is necessary to separately manage different form data respectively provided for an even page and an odd page. As a result, management cost cannot be reduced. Also, in the method discussed in Japanese Patent Application Laid-Open No. 8-80643, changing of a form template is only using different form pages respectively for an even page and an odd page. For example, interchanging some fields defined in a form template is not feasible.

As described above, in the conventional methods, it is difficult to flexibly change the layout of fields defined in a print form, such as a form template.

### SUMMARY OF THE INVENTION

An embodiment of the present invention is directed to a print data generating apparatus capable of flexibly changing the layout of fields defined in a print form.

According to an aspect of the present invention, an embodiment is directed to an apparatus configured to generate print data based on a print form having a plurality of field areas defined therein into which data can be inserted and to output the print data to a printing apparatus. The apparatus includes a first receiving unit configured to receive setting of a condition concerning changing of a layout of at least one field area of the plurality of field areas defined in the print form, a changing unit configured to change a layout of the at least one field area defined in the print form according to the condition received by the first receiving unit, and a print data generating unit configured to generate print data based on the print form having the layout of the at least one field area changed by the changing unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration example of a printing system according to a first exemplary embodiment of the present invention.

FIG. 2 illustrates an example of a hardware configuration of a server personal computer (PC) and a client PC according to the first exemplary embodiment of the present invention.

FIG. 3 illustrates an example of a functional configuration of a server PC and a client PC according to the first exemplary embodiment of the present invention.

FIG. 4 illustrates a selection example of a dynamic area in a form template according to the first exemplary embodiment of the present invention.

FIG. 5 illustrates an example of a dialog box adapted to set a layout changing method and an operating condition for field included in a dynamic area according to the first exemplary embodiment of the present invention.

FIG. 6 illustrates an output example of data for form printing according to the first exemplary embodiment of the present invention.

FIG. 7 is a flowchart illustrating an example of an operation of the client PC when it specifies a dynamic area according to the first exemplary embodiment of the present invention.

FIG. 8 is a flowchart illustrating an example of an operation of the client PC when it outputs data for form printing according to the first exemplary embodiment of the present invention.

FIG. 9 illustrates an example of a layout of rearrangeable fields when a dynamic area is specified separately according to a second exemplary embodiment of the present invention.

FIGS. 11A and 10B illustrate a selection example of a dynamic area in a form template according to the second exemplary embodiment of the present invention.

FIG. 11 illustrates a concept of a method for data management of the dynamic area according to the second exemplary embodiment of the present invention.

FIG. 12 is a flowchart illustrating an example of an operation of a client PC when it specifies a dynamic area according to the second exemplary embodiment of the present invention.

FIG. 13A illustrates an example of a plurality of fields which are defined and grouped in a form template and FIG. 13B illustrates an example of changing a layout of such fields according to a third exemplary embodiment of the present invention.

FIG. 14 illustrates an example of a dialog box adapted to set a layout changing method and an operating condition for fields included in a group according to the third exemplary embodiment of the present invention.

FIG. 15 illustrates an example of changing positions of first to fifth fields included in the group according to the third exemplary embodiment of the present invention.

FIG. 16 illustrates an example of a dialog box adapted to set a layout changing method and an operating condition for fields defined in a form template on a field-by-field basis according to a fourth exemplary embodiment of the present invention.

FIG. 17 illustrates an example of changing a field layout according to the fourth exemplary embodiment of the present invention.

FIG. 18 is a flowchart illustrating an example of an operation of the client PC when it outputs data for form printing according to the fourth exemplary embodiment of the present invention.

### DETAILED DESCRIPTION OF THE EMBODIMENTS

Various exemplary embodiments, features, and aspects of the invention will be described in detail below with reference to the drawings.

### First Exemplary Embodiment

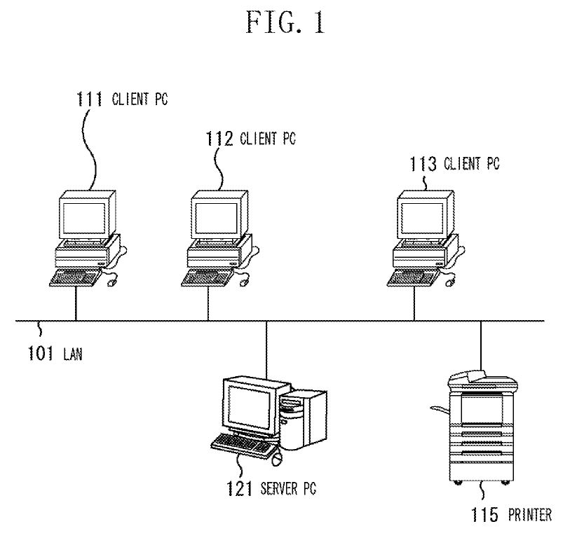

FIG. 1 illustrates a configuration example of a printing system according to a first exemplary embodiment of the present invention. In the printing system illustrated in FIG. 1, a client personal computer, which generates and outputs a form, gives instruction to a server personal computer which offers form management.

In FIG. 1, client personal computers 111-113, a server personal computer 121, and a printer 115 are connected to a local area network (LAN) 101. In the following description, a client personal computer is referred to as a “client PC” and a server personal computer is referred to as a “server PC”.

The server PC 121 according to the first exemplary embodiment also functions as a form management server. More specifically, the server PC 121, for example, receives an instruction from the client PCs 111-113 based on an input operation by a user using a web browser installed on the client PCs 111-113. Based on that instruction, the server PC 121, for example, sends a client PC a form template being one type of a print form or a web document used for displaying a list image of data to be inserted into the form template. Then, the client PC sends the server PC 121 an instruction from the user to search for a form template or data to be inserted into the form template. When the server PC 121 receives the instruction from the user to search for the form template or data to be inserted into the form template, the server PC 121 searches for such form template or data accordingly. When the search is finished, the server PC 121 sends the client PC the retrieved form template or data to be inserted into the form template.

Programs for generating and outputting a form are installed on the client PCs 111-113. The web browser, which is one type of such programs, is used to acquire a web document from the server PC 121 and to display the acquired web document on a display apparatus. The web document is used to, for example, display an image required to generate and output a form, such as a form template retrieved by the server PC 121 and an image list of data to be inserted into the form template. When the client PC 111-113 receives an instruction from the user based on an input operation on the web document (web browser) sent from the server PC 121, the client PC 111-113 generates and outputs a form. More specifically, the client PC 111-113 requests the server PC 121 to send, for example, a form template or an image list of data to be inserted into the form template based on the user's input operation on the web document (web browser). Then, the client PC 111-113 acquires the form template and data to be inserted in the form template from the server PC 121. Then, the client PC 111-113 inserts data into a field defined in the form template to generate data for form printing, and sends the data for form printing to the printer 115. The printer 115 prints the data for form printing sent from the client PC 111-113.

FIG. 1 illustrates three client PCs 111-113, one server PC 121, and one printer 115. However, the number of the client PCs, the server PC, and the printer is not limited to such numbers. Also, although the client PCs 111-113, the server PC 121, and the printer 115 are connected to the LAN 101 in FIG. 1, the client PCs 111-113, the server PC 121, and the printer 115 can be connected in a different manner. For example, the client PCs 111-113 and the server PC 121 can be interconnected via the Internet while the client PCs 111-113 and the printer 115 are interconnected via a Universal Serial Bus (USB) cable.

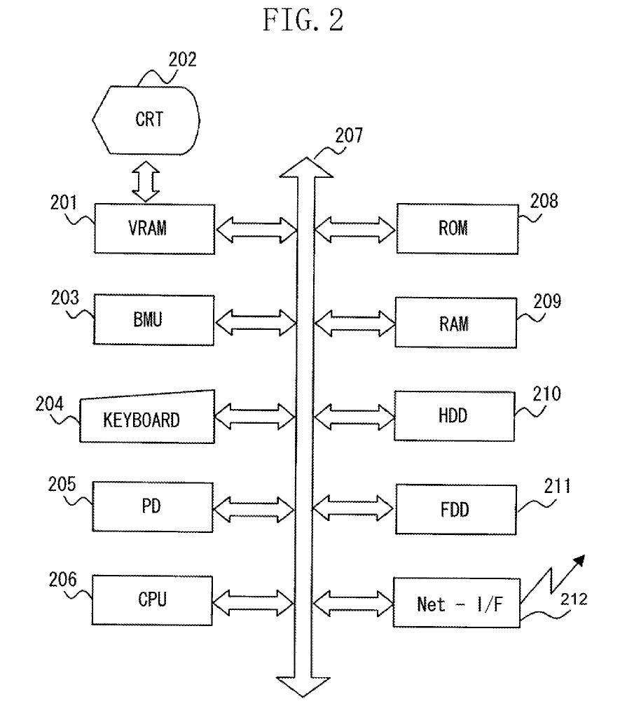

FIG. 2 illustrates an example of a hardware configuration of the server PC 121 and the client PCs 111-113. In FIG. 2, a video random access memory (VRAM) 201 loads and stores a character or an image to be displayed on a screen of a cathode-ray tube display apparatus (CRT) 202. A bit move unit (BMU) 203 controls transfer of data between memories or between a memory and a device. A keyboard 204 is a user interface with various input keys.

A pointing device (PD) 205 is a user interface used for pointing to an icon, etc., on the screen. A central processing unit (CPU) 206 controls every part of the server PC 121 or the client PCs 111-113 based on a control program stored in a hard disk, etc. This control program includes a program for processing which is described later. A random access memory (RAM) 209 is used as a work area when the CPU 206 executes the control program. The RAM 209 is also used as a temporary save area when the CPU 206 detects an error and temporarily needs to save data, etc. A hard disk drive (HDD) 210 stores and controls reading and writing of various data including an application program, data, database, and library on the hard disk. A flexible disk drive (FDD) 211 controls reading and writing of various data stored in a flexible disk which is used for storing various types of data including application program, data, database, and library.

A network interface (NET-I/F) 212 performs data control or diagnosis on a network so as to transfer data to an external device via the LAN 101, etc. An input/output (I/O) bus 207 is used for connecting each unit mentioned above. The I/O bus 207 includes an address bus, a data bus, and a control bus.

When the server PC 121 or the client PC 111-113 is powered on, the CPU 206 initializes the server PC 121 or the client PC 111-113 according to a boot program stored in a read-only memory (ROM) 208. Then, for example, after loading an operating system (OS) from the HDD 210, the CPU 206 executes an application program, etc.

It is to be noted that the server PC 121 and the client PCs 111-113 of the first exemplary embodiment are personal computers which are a general-purpose information processing apparatus. Thus, a computer-executable program is stored in a hard disk, etc. However, a storage medium for the program is not limited to a hard disk. For example, the program can be stored in the ROM 208. It is to be understood that the present invention is not limited according to a type of a storage medium.

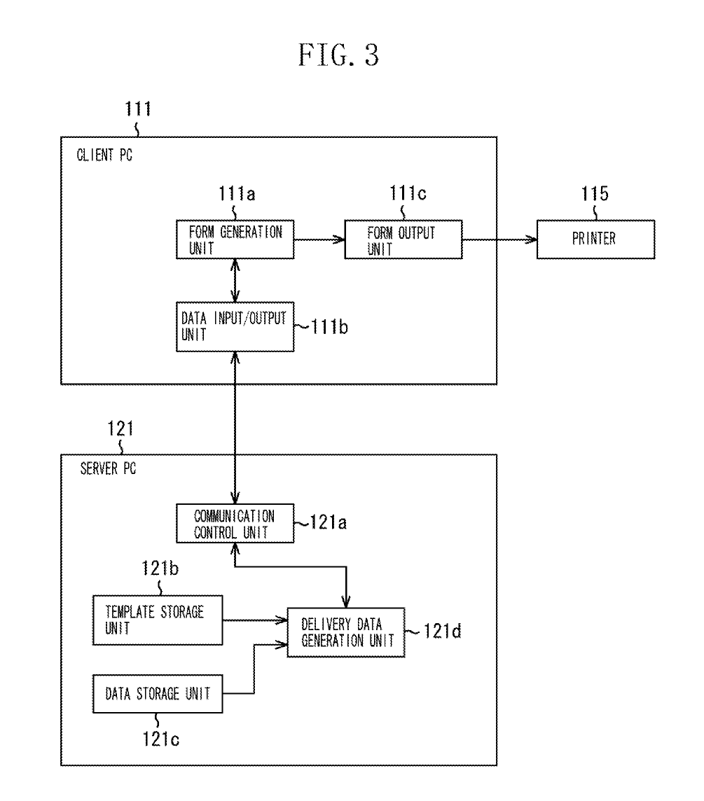

FIG. 3 illustrates an example of a functional configuration of the server PC 121 and the client PCs 111-113. It is to be noted that since the client PCs 111-113 have a similar configuration, the client PC 111 will be described as being representative of the client PCs 111-113. Descriptions of the PCs 112 and 113 will be omitted accordingly.

In FIG. 3, the client PC 111 includes a form generation unit 111a, a data input/output unit 111b, and a form output unit 111c. The form generation unit 111a generates data for form printing and includes various programs used in generating data for form printing, such as a web browser, etc. As described above, the web browser is an application program which allows the user to display data such as a web document sent from the server PC 121 on a display apparatus.

The data input/output unit 111b is used when the client PC 111 exchanges data with an external device, such as the server PC 121. The form output unit 111c outputs data for form printing generated by the form generation unit 111a to the printer 115.

The server PC 121 includes a transmission control unit 121a, a template storage unit 121b, a data storage unit 121c, and a delivery data generation unit 121d. The transmission control unit 121a sends data, such as a web document in HTML format, etc., to the client PCs 111-113 upon their request. The template storage unit 121b stores one or more form templates (form template data). One or more data insertable fields are defined in each form template stored in the template storage unit 121b.

The data storage unit 121c stores various data to be inserted into fields of the form template. The data storage unit 121c also stores prestored data and data generated by the client PCs 111-113 using the web browser. The delivery data generation unit 121d receives data input in the web browser from the client PCs 111-113 via the transmission control unit 121a. Then, the delivery data generation unit 121d generates a web document according to the received data and sends the generated web document to the transmission control unit 121a.

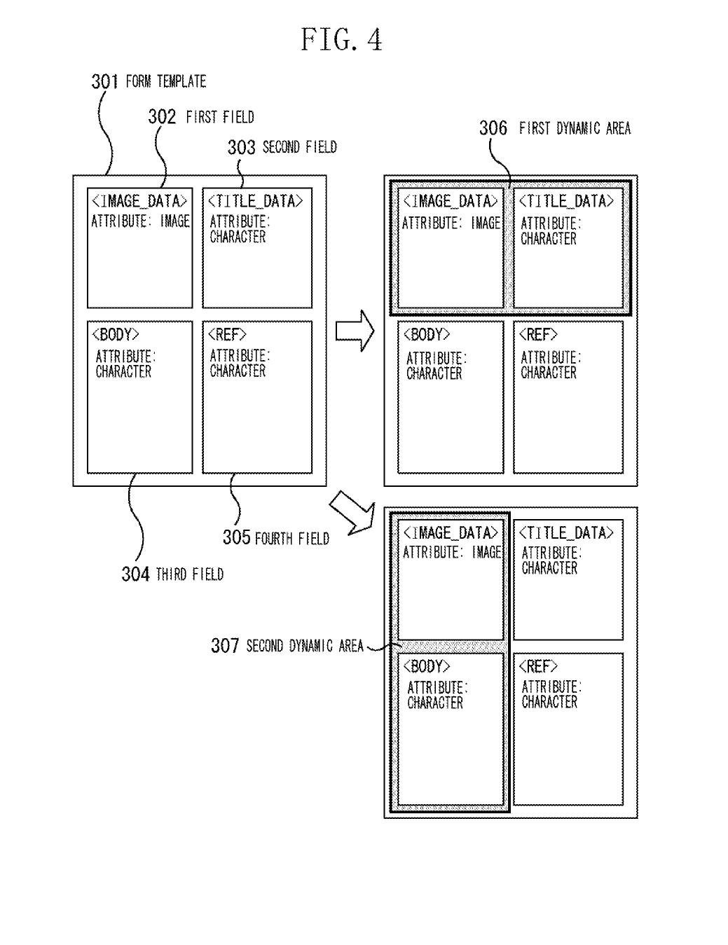

FIG. 4 illustrates an example of a selection of a dynamic area in the form template. In a form template 301, four fields or a first field 302 through a fourth field 305 are defined. The first field 302 is a field with an identifier “IMAGE_DATA” and has image as its attribute. The second field 303 is a field with an identifier “TITLE_DATA” and has character as its attribute. The third field 304 is a field with an identifier “BODY” and has character as its attribute. The fourth field 305 is a field with an identifier “REF” and has character as its attribute.

The user of the client PC 111-113 specifies a first dynamic area 306 in the form template 301 with the PD 205 or the like. Then, as illustrated in an upper right portion of FIG. 4, the first field 302 and the second field 303 in the first dynamic area 306 are selected as object fields for a layout change.

Likewise, when the user of the client PC 111-113 specifies a second dynamic area 307, the first and the third fields 302 and 304 are selected as object fields for a layout change as illustrated in a lower right portion of FIG. 4. It is to be noted that although only two fields are selected from the four fields 302-305 in FIG. 4, all of the four fields 302-305 can be selected.

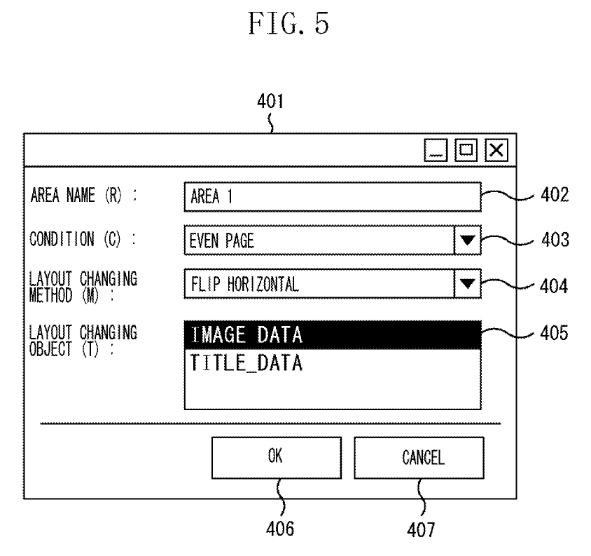

FIG. 5 illustrates an example of a dialog box used for setting a layout changing method and an operating condition for fields in the dynamic area 306 or 307 which is selected as illustrated in FIG. 4. A dialog box 401 illustrated in FIG. 5 is displayed on the CRT 202 of the client PC 111-113 after the dynamic area 306 or 307 is selected as illustrated in FIG. 4. In FIG. 5, the first dynamic area 306 is selected.

A control (text box) 402 in the dialog box 401 is used for setting a name of an object dynamic area. The user sets the area name using the text box 402. In FIG. 5, “AREA 1” is set as a name for the first dynamic area 306. A control (list box) 404 is adapted to specify a layout changing method for fields in the object dynamic area. In FIG. 5, “FLIP HORIZONTAL” is selected as a layout changing method for the first field 302 and the second field 303 in the first dynamic area 306. In the present embodiment, “FLIP HORIZONTAL” indicates that object fields in the dynamic area are flipped horizontally.

It is to be noted that various figural position changing methods, such as “FLIP VERTICAL”, “SLIDE”, “ROTATE” as well as “FLIP HORIZONTAL”, can be selected and applied. In other words, a different layout changing method can be applied so long as it is a method that changes a layout of object fields. In the present embodiment, the layout of object fields is changed within the dynamic area.

A control (list box) 403 is used for setting an operating condition of the layout changing method specified via the list box 404 concerning an object dynamic area. In FIG. 5, “EVEN PAGE” is selected via the list box 403. In the present embodiment, “EVEN PAGE” indicates that a layout changing method specified via the list box 404 is applied to fields arranged on an even page. More specifically, the first field 302 and the second field 303 arranged on an even page are flipped horizontally.

It is to be noted that an operating condition of the layout changing method is, for example, defined by various conditions such as a condition determined by page configuration, an arbitrary condition set by the user at the time of output, a condition determined by content of the form, etc. In other words, the operating condition of the layout changing method is not limited.

A control (text box) 405 indicates fields included in the object dynamic area. In FIG. 5, the first field 302 (field with an identifier “IMAGE_DATA”) and the second field 303 (field with an identifier “TITLE_DATA”) included in the first dynamic area 306 are selected. A button 406 is adapted to confirm and close the dialog box 401 whereas a button 407 is adapted to cancel and close the dialog box 401.

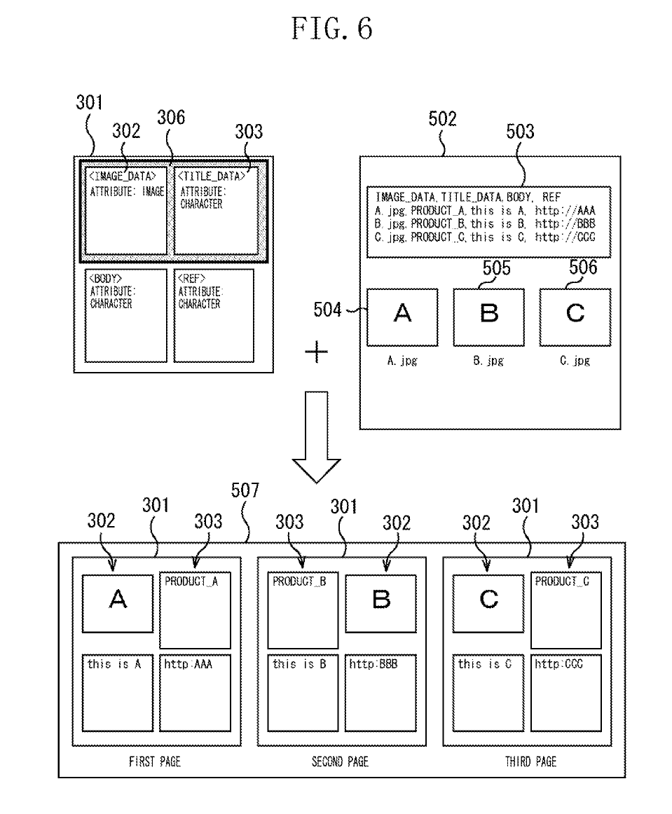

FIG. 6 illustrates an output example of data for form printing. In FIG. 6, the first dynamic area 306 illustrated in FIG. 4 is selected and the content of the dialog box 401 in FIG. 5 is set. In other words, FIG. 6 illustrates a case where the first field 302 and the second field 303 included in the first dynamic area 306 are flipped horizontally when the output page is an even page.

In FIG. 6, an output data group 502 is stored in the data storage unit 121c of the server PC 121. Output data 503 is used for specifying text data and a file name to be inserted into fields. In the first line of the output data 503, an identifier of the object field is specified. Also, in the second line to the fourth line of the output data 503, text data and a file name to be inserted into each field are specified. Image files 504, 505, and 506 are specified by the output data 503.

Taking the second line of the output data 503 as an example, an image file 504 whose file name is “A.jpg” is specified for a field having “IMAGE_DATA” as an identifier. Text data “PRODUCT_A” is specified for a field having “TITLE_DATA” as an identifier. Likewise, text data “this is A” is specified for a field having “BODY” as a identifier and text data “http://AAA” is specified for a field having “REF” as an identifier. It is to be noted that the description method for the output data 503 is not to be construed as limited. The description method can be, for example, in XML (extensible Markup Language) format or a unique data description method.

Data for form printing 507 indicates a state when the output data group 502 is applied to the first dynamic area 306 set in the form template 301. The “first page” of the data for form printing 507 is an odd page. In FIG. 6, as described above, the first field 302 and the second field 303 included in the first dynamic area 306 are flipped horizontally only when an even page is output. Thus, the first field 302 and the second field 303 which are on the first page are not flipped horizontally. In other words, the first field 302 and the second field 303 into which the output data group 502 is inserted are output without changing their positions when the fields 302 and 303 are arranged on the first page.

On the other hand, since the “second page” of the data for form printing 507 is an even page, the layout changing method is applied to the first dynamic area 306. The first field 302 and the second field 303 are flipped horizontally in the first dynamic area 306. As a result, the first field 302, into which an image file 505 with a file name “B.jpg” is inserted, is arranged on the right side of the form template 301. On the other hand, the second field 303, into which text data “PRODUCT_B” for a field with an identifier “TITLE_DATA” is inserted, is arranged on the left side of the form template 301. Also, since the “third page” of the data for form printing 507 is an odd page, its output is arranged in the same manner as is with the “first page”.

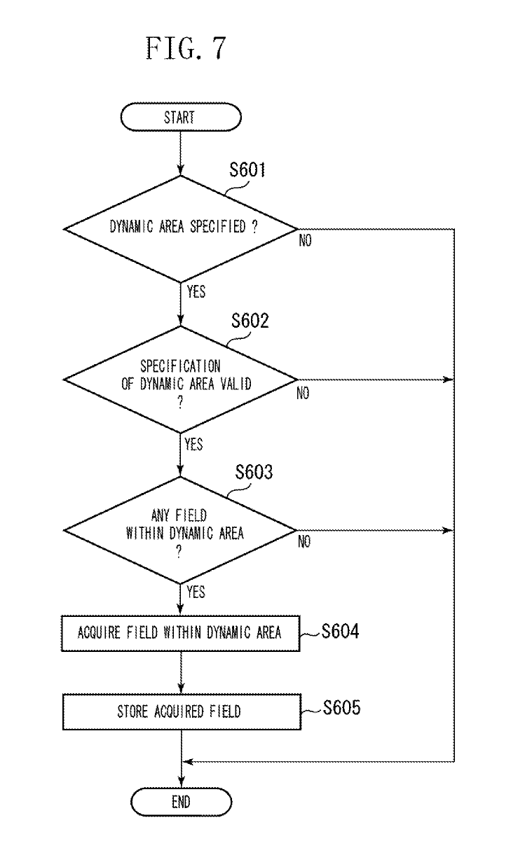

Next, referring to a flowchart illustrated in FIG. 7, an example of an operation of the client PC 111-113 for specifying a dynamic area will be described. The process illustrated in FIG. 7 starts after an image of a form template, such as the one illustrated in FIG. 4, is displayed on the CRT 202 by the application program installed on the client PC 111-113.

First, in step S601, based on an operation by the user using, for example, the PD 205, the client PC determines whether a dynamic area is specified. As a result of this determination, if no dynamic area is specified (NO in step S601), the process ends. On the other hand, if a dynamic area is specified (YES in step S601), the process proceeds to step S602.

In step S602, the client PC determines whether the dynamic area determined as specified in step S601 is valid. More specifically, for example, if an area outside the form template 301 is specified or a previously-selected field is selected again, the specified dynamic area is determined to be invalid (NO in step S602), and the process ends. On the other hand, if the specified dynamic area is valid (YES in step S602), the process proceeds to step S603.

In step S603, the client PC determines whether a field exists within the specified dynamic area. As a result of this determination, if no field exists in the specified dynamic area (NO in step S603), the specified dynamic area is determined to be invalid, and the process ends. On the other hand, if one or more fields exist in the specified dynamic area (YES in step S603), the process proceeds to step S604.

In step S604, the client PC acquires all fields within the specified dynamic area and generates a list the fields included within the specified dynamic area. Further, in step S605, the client PC stores all of the fields acquired in step S604 in a storage medium (for example, a hard disk), and then the process ends.

When the dynamic area is specified in the form template 301 according to the process illustrated in the flowchart of FIG. 7, all of the fields included in the dynamic area are listed automatically.

When the dynamic area is specified and all of the fields included in the dynamic area are stored, the client PC displays the dialog box 401 illustrated in FIG. 5 according to an application program. Then, the client PC stores the name, the layout changing method, the operating condition of the dynamic area, and also the dynamic area itself, all of which are set in the dialog box 401, in a storage medium (for example, a hard disk).

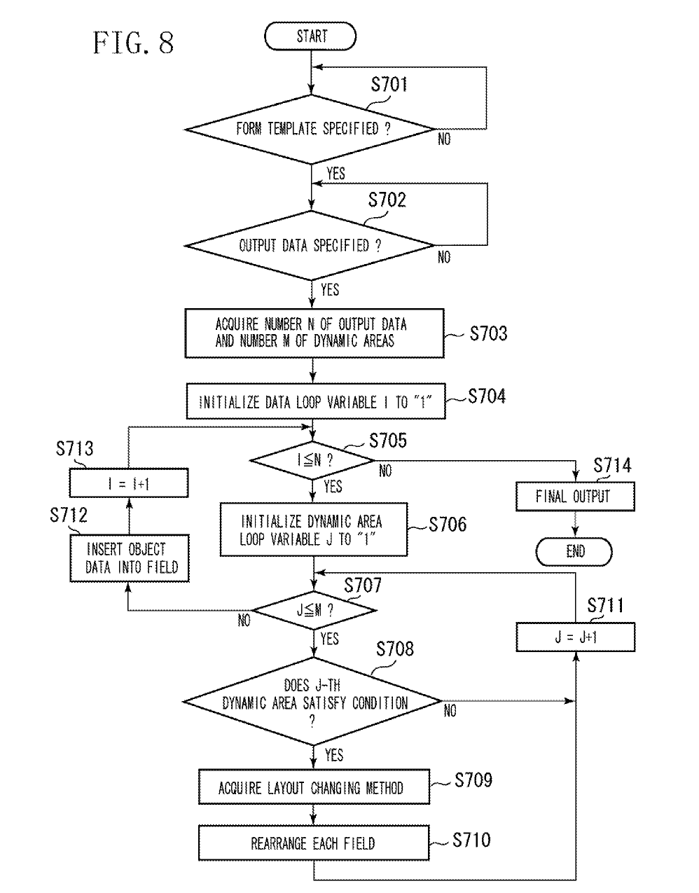

Next, referring to the flowchart of FIG. 8, an example of an operation of the client PCs 111-113 for outputting data for form printing will be described. The process illustrated in FIG. 8 starts after the dialog box 401 illustrated in FIG. 5 is set.

First, in step S701, the client PC waits until the user specifies a form template which is used for outputting via the PD 205, etc. More specifically, for example, the client PC inquires the server PC using the web browser, acquires a web document which presents a list of form templates, and displays the acquired list of form templates. Then, the client PC waits until the user selects a desired form template from the displayed list of form templates. The form template specified in step S701 is used for outputting a form.

Next, in step S702, the client PC waits until the user specifies output data with an operation of the PD 205, etc. More specifically, for example, the client PC acquires a web document which indicates a list of output data (for example, the output data 503 or the image files 504-506) and displays the acquired output data. Then, the client PC waits until the user selects desired output data from the displayed output data.

In steps S701 and S702, a method for collecting a form template, an image file, and output data is not construed as limited to the aforementioned method, and various methods including a common search method and prepared data can also be used.

Next, in step S703, the client PC acquires the number N of output data specified in step S702 and the number M of dynamic areas specified in the form template specified in step 701.

In step S704, the client PC initializes a data loop variable I to “1”. The data loop variable I is used for processing the output data. It is to be noted that a setting method for the data loop variable I is not limited and a common method can also be used.

Next, in step S705, the client PC determines whether the number N of output data is equal to or greater than the data loop variable I. As a result of this determination, if the number N of output data is smaller than the data loop variable I (NO in step S705), the process proceeds to step S714. On the other hand, if the number N of output data is equal to or greater than the data loop variable I and when there is output data to be processed (YES in step S705), the process proceeds to step S706.

In step S706, the client PC initializes a dynamic area loop variable J to “1”. The dynamic area loop variable J is used for checking all dynamic areas in the form template. It is to be noted that a setting method for the dynamic area loop variable J is not limited and a common method can also be used.

Next, in step S707, the client PC determines whether the number M of dynamic areas specified in the form template specified in step S701 equals to or greater than the dynamic loop variable J. As a result of this determination, if the number M of dynamic areas is smaller than the dynamic area loop variable J (NO in step S707), the process proceeds to step S712. On the other hand, if the number M of dynamic areas is equal to or greater than the dynamic area loop variable J and when there is an unprocessed dynamic area (YES in step S707), the process proceeds to step S708.

In step S708, the client PC determines whether the J-th dynamic area satisfies the condition set in the dialog box 401. As a result of this determination, if the J-th dynamic area does not satisfy the condition set in the dialog box 401 (NO in step S708), the process proceeds to step S711. On the other hand, if the J-th dynamic area satisfies the condition set in the dialog box 401 (YES in step S708), the process proceeds to step S709.

In step S709, the client PC acquires a layout changing method which is set for a dynamic area determined to satisfy the condition set in the dialog box 401.

In step S710, the client PC changes the layout of fields in the object dynamic area into a form for outputting data based on the layout changing method acquired in step S709. The process in step S710 temporarily changes only the layout of fields and thus does not affect the original layout of fields.

In step S711, the client PC adds “1” to the dynamic area loop variable J so as to process the next dynamic area.

Then, the process returns to step S707. The changing of a field layout for the I-th output data is made during steps S706 through S711.

If the number M of dynamic areas defined in the form template is smaller than the dynamic area loop variable J and processing has been applied to all of the dynamic areas defined in the form template, the process proceeds to step S712.

In step S712, the client PC inserts the I-th output data (for example, text data or image data) into a form template field whose layout is fixed in steps S706 through S711. A field layout change and a form output for one output data are made in steps S706 through S712.

In step S713, the client PC adds “1” to the data loop variable I so as to process the next data. Then, the process returns to step S705.

In step S705, if the number N of output data is smaller than the data loop variable I and processing has been applied to all of output data (NO in step S705), the process proceeds to step S714. In step S714, the client PC organizes forms which are generated for each output data to generate final output data for form printing, and outputs the generated data for form printing to the printer 115. It is to be noted that organizing forms which are generated for each output data to generate final output data for form printing can be accomplished by simply combining the forms generated for each output data. However, the method for organizing forms is not limited, and a different process can be employed.

According to the steps illustrated in the flowchart of FIG. 8, the layout of fields in a dynamic area which is specified within a form template can be changed during outputting depending on a condition set via the dialog box 401.

As described above, according to the first exemplary embodiment, a dynamic area can be specified for fields defined in a form template. Also, a layout changing method for the layout of fields within a dynamic area and an operation condition for the layout changing method are set via the dialog box 401. In this way, the layout of fields which satisfies the operating condition can be changed according to the layout changing method. For example, the first field 302 and the second field 303 within the first dynamic area 306, which are defined within the form template 301 for an even page, can be flipped horizontally. Thus, the layout of fields defined in a form template can be changed flexibly, and a plurality of form templates having different layouts but with the same field number and content can be managed as one template. Also, since defining an area of the form template 301 defines a field area to be changed, easier layout changing can be achieved.

In the first exemplary embodiment, the client PCs 111-113 and the server PC 121 communicate with each other using a web browser. However, a communication method between the client PCs 111-113 and the server PC 121 is not limited to a web browser. The client PCs 111-113 can directly instruct the server PC 121 without using a web browser.

Also, in the first exemplary embodiment, the client PC 111-113 inserts output data into a form template. However, this processing can be performed by the server PC 121.

### Second Exemplary Embodiment

Next, a second exemplary embodiment of the present invention will be described. While a dynamic area is specified separately according to the first exemplary embodiment, a dynamic area including one or a plurality of previously-defined dynamic areas can further be specified according to the second exemplary embodiment. Then, data of one or a plurality of previously-defined dynamic areas and data of the dynamic area including such dynamic areas are arranged in a hierarchical manner for management. Thus, a difference between the first exemplary embodiment and the second exemplary embodiment relates to software processing for changing a field layout. Accordingly, in the description of the second exemplary embodiment, the same reference numerals as those illustrated in FIGS. 1 through 8 are applied to the parts which are similar to those in the first exemplary embodiment, and detailed descriptions thereof will be omitted.

Before describing the second exemplary embodiment, an issue which can be solved by the second exemplary embodiment will be explained.

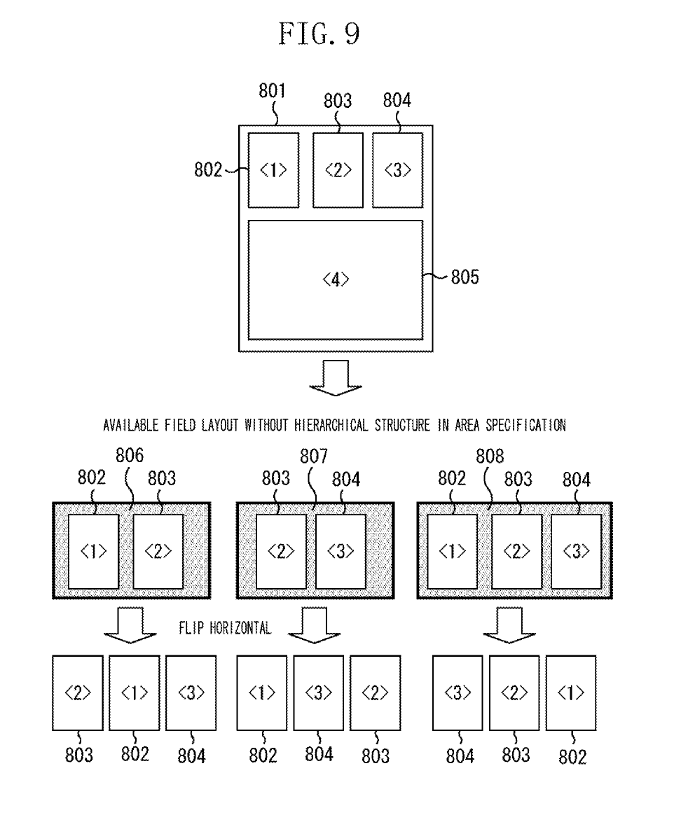

FIG. 9 illustrates an example of a changeable layout of fields when a dynamic area is specified separately. In FIG. 9, fields within the specified dynamic area are flipped horizontally. As illustrated, a first field 802 through a fourth field 805 in a form template 801 have an identifier <1>, <2>, <3>, and <4>, respectively. While the first field 802 through the third field 804 are arranged horizontally at the upper portion of the form template 801, the fourth field 805 is arranged at the lower portion of the form template 801.

Here, a case where an area including the first field 802 through the third field 804 is specified independently as is with the dynamic area in the first exemplary embodiment is taken as an example. In this case, it is possible to specify three dynamic areas, a first dynamic area 806 through a third dynamic area 808. By horizontally flipping the fields within the first dynamic area 806 through the third dynamic area 808, the first dynamic area 806 will have the second field 803, the first field 802, and the third field 804 arranged in this order from the left. Similarly, the second dynamic area 807 will have the first field 802, the third field 804, and the second field 803 arranged in this order from the left. Further, the third dynamic area 808 will have the third field 804, the second field 803, and the first field 802 arranged in this order from the left.

However, specifying the dynamic areas separately will not allow such an arrangement as the second field 803, the third field 804, and the first field 802 arranged in this order from the left. Further, an arrangement in the order of the third field 804, the first field 802, and the second field 803 from the left cannot be attained. Thus, there is a limitation in the layout change when separately specifying a dynamic area. Therefore, in the second exemplary embodiment, a field layout change can be made more flexible compared to the case where a dynamic area is specified separately.

FIGS. 10A and 10B illustrate a selection example of a dynamic area within a form template. It is to be noted that in FIGS. 10A and 10B, fields in a specified dynamic area are flipped horizontally. In FIG. 10A, a dynamic area 901 is similar to the second dynamic area 807 illustrated in FIG. 9 and includes the second field 803 and the third field 804. A dynamic area 902 includes the dynamic area 901 and the first field 802.

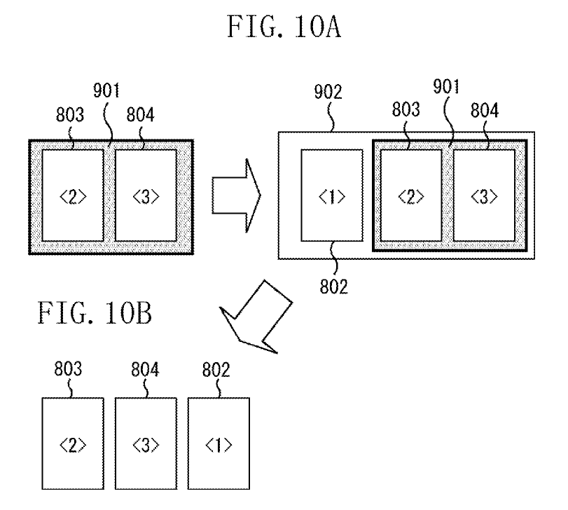

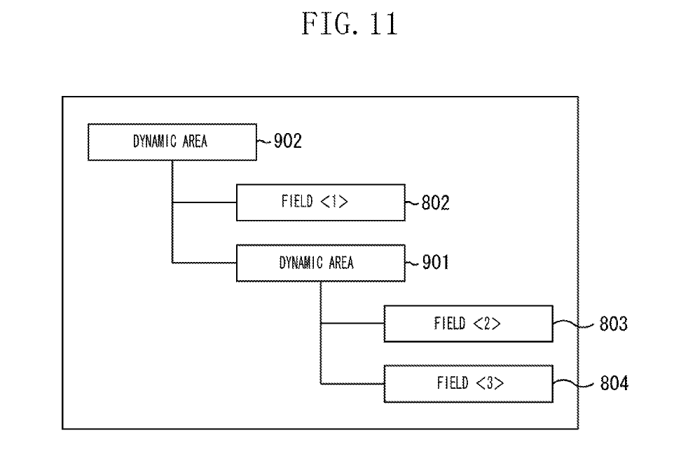

Suppose that the dynamic area 901 does not satisfy the condition set via the list box 403 in the dialog box 401 illustrated in FIG. 5 while the dynamic area 902 does. Then, the first field 802 through the third field 804 in FIG. 11A are arranged as illustrated in FIG. 10B.

More specifically, when processing described below is executed, a layout illustrated in FIG. 10B is realized. Processing starts with the dynamic area 901. Since the dynamic area 901 does not satisfy the condition set via the list box 403 in the dialog box 401, the position of the second field 803 and the position of the third field 804 within the dynamic area 901 remain unchanged. Next, the dynamic area 902 is processed. Since the dynamic area 902 satisfies the condition set via the list box 403 in the dialog box 401, the position of the dynamic area 901 and the position of the first field 802 are flipped horizontally. This results in an arrangement illustrated in FIG. 10B. The first field 802 is arranged on the right while the dynamic area 901 (the second field 803 and the third field 804) is arranged on the left.

FIG. 11 is a conceptual illustration of a method for managing data of a selected dynamic area as illustrated in FIGS. 11A and 10B. According to the second exemplary embodiment, the client PC 111-113 organizes data of the dynamic areas 901 and 902 and the first field 802 through the third field 804 in a hierarchical manner as illustrated in FIG. 11. In other words, the client PC 111 through 113 places the dynamic area 902 at the highest level, the first field 802 and the dynamic area 901 at the subsequent level, and the second field 803 and the third field 804 within the dynamic area 901 at the lowest level. In this way, in FIG. 11, the dynamic area 902 is at a parent level having the dynamic area 901 as a child.

Also, according to the second exemplary embodiment, the client PC 111-113 is capable of displaying a hierarchical structure illustrated in FIG. 11 on the CRT 202 according to the application program. The user is thus able to easily understand whether a dynamic area can be specified as intended.

It is to be noted that only field data is selected via the text box 405 in the dialog box 401 illustrated in FIG. 5 according to the first exemplary embodiment. However, according to the second exemplary embodiment, both a field and a dynamic area can be selected via the text box 405. Since other configurations of the dialog box 401 are similar to the configurations illustrated in FIG. 5, their descriptions are omitted.

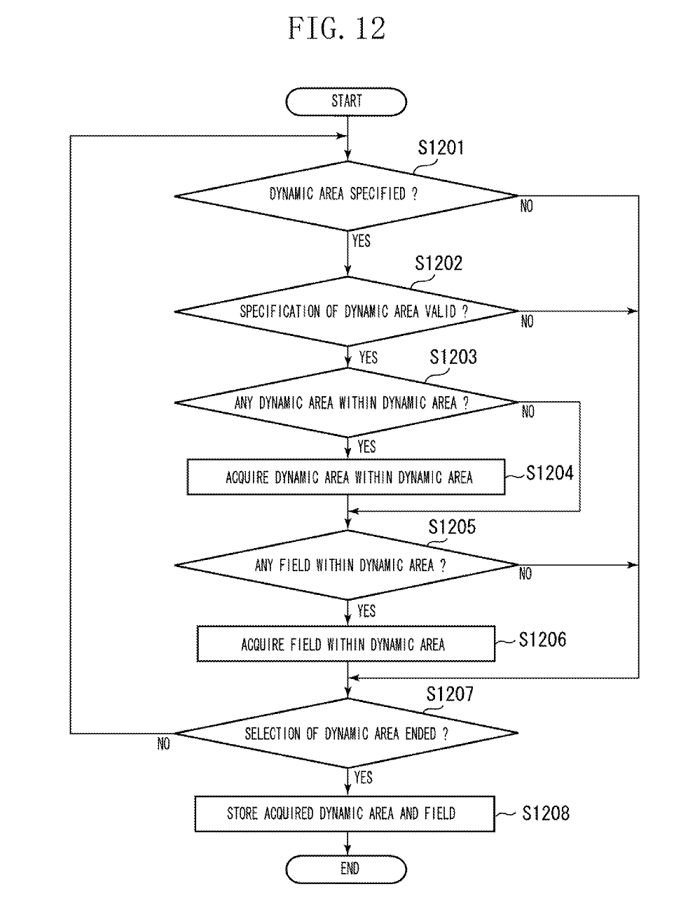

Next, referring to the flowchart of FIG. 12, an example of an operation of the client PC 111 through 113 for specifying a dynamic area will be described. The processing illustrated in FIG. 12 starts after an image of a form template, such as the one illustrated in the top of FIG. 9, is displayed on the CRT 202 according to the application program installed on the client PC 111 through 113.

First, in step S1201, based on an operation by the user using, for example, the PD 205, the client PC determines whether a dynamic area is specified. As a result of this determination, if no dynamic area is specified (NO in step S1201), the process proceeds to Step S1207. On the other hand, if a dynamic area is specified (YES in step S1201), the process proceeds to step S1202.

In step S1202, the client PC determines whether the dynamic area determined as specified in step S1201 is valid. As a result of this determination, if the specified dynamic area is determined as not valid (NO in step S1202), the process proceeds to step S1207. On the other hand, if the specified dynamic area is valid (YES in step S1202), the process proceeds to step S1203.

In step S1203, the client PC determines whether a dynamic area exists in the dynamic area determined as specified in step S1201. As a result of this determination, if no dynamic area exists in the specified dynamic area (NO in step S1203), the process proceeds to step S1205. On the other hand, if one or more dynamic areas exist in the specified dynamic area (YES in step S1203), the process proceeds to step S1204. Here, since the dynamic area 901 exists in the dynamic area 902 in FIG. 10A, the process proceeds to step S1204.

In step S1204, the client PC acquires all of dynamic areas included in the dynamic area determined as specified in step S1201 and makes their list.

In step S1205, the client PC determines whether a field exists in the dynamic area determined as specified in step S1201. As a result of this determination, if no field exists in the specified dynamic area (NO in step S1205), the process proceeds to step S1207. On the other hand, if one or more fields exist in the specified dynamic area (YES in step S1205), the process proceeds to step S1206.

In step S1206, the client PC acquires all of fields included in the dynamic area determined as specified in step S1201 and makes their list.

Next, in step S1207, the client PC determines whether a selection operation of the dynamic area by the user is finished. For example, the client PC can determine whether the user has finished selecting the dynamic area when, for example, a button for terminating selection of the dynamic area is displayed on the CRT 202 and the displayed button is pressed. However a different determination method can be employed. As a result of this determination, if the selection operation is not terminated (NO in step S1207), steps S1201 through S1207 are repeated until the selection operation of the dynamic area ends. When the selection operation by the user ends (YES in step S1207), the process proceeds to step S1208.

In step S1208, the client PC organizes the dynamic area and the field acquired in steps S1204 and S1206 in a hierarchical manner as illustrated in FIG. 11 and stores them in a storage medium (for example, a hard disk). Then, the process ends. It is to be noted that, if no dynamic area or field is included in the dynamic area specified in step S1201, the process ends without performing the process in step S1208.

The operation of the client PC 111 through 113 for outputting data for form printing is similar to the flow illustrated in FIG. 8 except for step S710. In other words, in step S710 in FIG. 7, the layout of fields in an object dynamic area is changed. However, according to the second exemplary embodiment, not only the layout of fields within the dynamic area but also the layout of a dynamic area within such dynamic area is changed. This processing is performed based on the content stored in step S1208 in FIG. 12. Also, as mentioned above, if a dynamic area within a dynamic area does not satisfy the condition set via the list box 403 in the dialog box 401, only the layout of a dynamic area which is to be changed is changed. The fields in the dynamic area keep their relative position in the dynamic area.

As described above, according to the second exemplary embodiment, an area which includes a previously specified dynamic area 901 is specified as a dynamic area 902. Also, the specified dynamic areas 901 and 902 and fields 802-804 within the dynamic areas 901 and 902 are managed in a hierarchical manner. Further, a layout changing method can be set for the dynamic area 901 within the specified dynamic area 902 and the fields 802-804. Thus, in addition to the advantage in the first exemplary embodiment, a layout change, which cannot be made when a dynamic area is specified separately, can be attained. In this way, a field layout can be changed more freely.

As with the first exemplary embodiment, the second exemplary embodiment takes an example in which the layout changing method is “FLIP HORIZONTAL”. However, various figural position changes, such as “FLIP VERTICAL”, “SLIDE”, and “ROTATE”, can be applied. In other words, the layout changing method is not limited so long as it is a method that changes the layout of fields in a dynamic area.

Also, although the dynamic areas 901 and 902 and the first field 803 through the third field 804 are organized in a hierarchical manner and managed by the client PC 111 through 113 as illustrated in FIG. 11, such data management can also be accomplished by the server PC 121. In this case, the client PC 111 through 113 communicates with the server PC 121 to exchange information on data and field concerning a specified dynamic area via a web browser, etc., of the client PC 111 through 113.

### Third Exemplary Embodiment

Next, a third exemplary embodiment of the present invention will be described. According to the first and the second exemplary embodiments, the dynamic area takes a part or whole area of the form template. On the other hand, according to the third exemplary embodiment, a plurality of fields defined in a form template are grouped. Thus, a difference between the first and the second exemplary embodiments and the third exemplary embodiment is that software processing for changing a field layout is different. Accordingly, regarding a description of the third exemplary embodiment, reference numerals in FIGS. 1-12 will be applied to parts that are similar to those of the first and the second exemplary embodiments. Detailed description thereof will, therefore, be omitted.

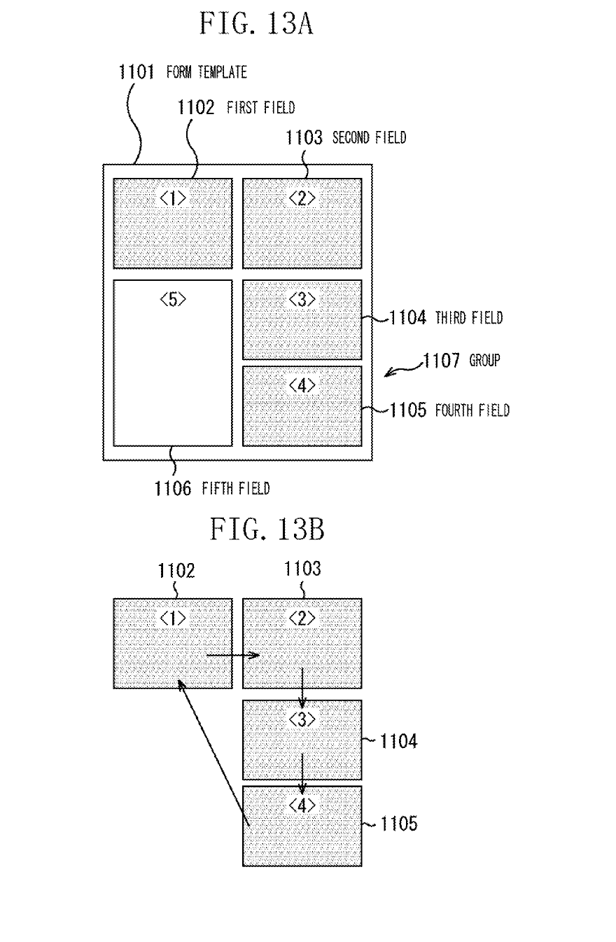

FIG. 13A illustrates an example of a plurality of fields defined in a form template, which are grouped. FIG. 13B illustrates a layout change example of a plurality of fields, which are grouped. In FIG. 13A, a form template 1101 includes five fields or the first field 1102 through the fifth field 1106. The first field 1102 through the fifth field 1106 have an identifier <1>, <2>, <3>, <4>, and <5>, respectively.

In FIG. 13A, the height of the fifth field 1106 is twice as much as the height of the first field 1102—the fourth field 1105. Also, the first field 1102 through the fifth field 1106 has the same width. According to an application program installed on the client PC 111 through 113, the user selects a field after an image of the form template 1101 is displayed on the CRT 202 as illustrated in FIG. 13A. In FIGS. 13A and 13B, the first field 1102 through the fourth field 1105, which are shaded, are selected according to the user's operation on the PD 205, etc. Then, when the user selects fields to be grouped by operating the PD 205, etc., the selected fields are grouped by the client PC 111 through 113. Then, the client PC 111 through 113 stores information on the grouped fields (group 1107) in a storage medium (for example, RAM 209). It is to be noted that a method for selecting fields and an instruction method for grouping are not limited.

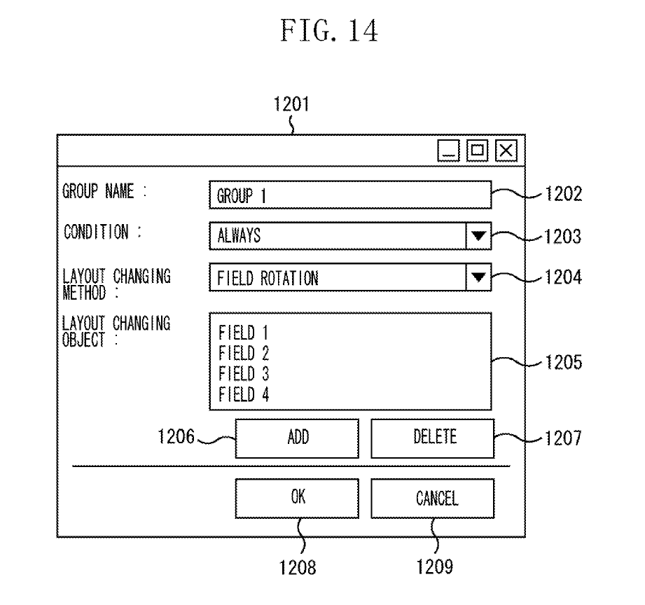

Then, according to the application program, the client PC 111-113 displays a dialog box 1201, such as the one illustrated in FIG. 14. By operating the PD 205, etc., the user enters necessary information in the dialog box 1201 to set a layout changing method for the grouped fields and an operating condition of the layout changing method. FIG. 14 illustrates an example of a dialog for setting a layout changing method for fields in the selected group 1107 and an operating condition of the layout changing method.

In FIG. 14, a control (text box) 1202 is used for setting a name of an object group. The user sets a group name using the text box 402. In FIG. 14, “GROUP 1” is set as a name for the selected group 1107.

A control (list box) 1204 is adapted to specify a layout changing method for fields in an object group. In FIG. 14, “FIELD ROTATION” is selected as a layout changing method for the first field 1102 through the fourth field 1105 in the group 1107. Here, “FIELD ROTATION” is a layout changing method used for rotating the position of fields in a group in a predetermined direction.

It is to be noted that various figural position changing methods, such as “SLIDE”, “FLIP VERTICAL”, “FLIP HORIZONTAL” as well as “FIELD ROTATION”, can be taken. In other words, a different layout changing method can be applied so long as it is a method that changes the layout of object fields. The position of object fields can be changed within the grouped area.

A control (list box) 1203 is used for setting an operating condition of the layout changing method concerning an object group, which is set via the list box 1204. In FIG. 14, “ALL” is selected via the list box 1203. Here, “ALL” indicates that the layout changing method selected via the list box 1204 is applied to all pages. It is to be noted that, as with the first and the second exemplary embodiments, an operating condition of the layout changing method is, for example, defined by various conditions, such as a condition determined by page configuration, an arbitrary condition set at the time of outputting, a condition determined by content of the form, etc.

A control (text box) 1205 indicates object fields included in the group. A field can be added in the text box 1205 by selecting a button 1206 and can be deleted by selecting a button 1207. FIG. 14 illustrates a state in which the first field 1102 through the fourth field 1105 within the group 1107 illustrated in FIG. 13A are selected. A button 1208 is used for applying the content of the dialog box 1201 and for ending process, whereas a button 1209 is used for canceling the dialog box 1201 and for ending the process.

When the dialog box 1201 is set as illustrated in FIG. 14, the positions of the first field 1102 through the fourth field 1105 are changed, for example, clockwise to the next field each time page is changed or data is output, as illustrated in FIG. 13B. For example, the first field 1102 shifts to the position of the second field 1103, and the second field 1103 shifts to the position of the third field 1104. Further, the third field 1104 shifts to the position of the fourth field 1105, and the fourth field 1105 shifts to the position of the first field 1102.

In this way, by allowing specification of a group, each field can be specified more freely compared to when a field is specified via a dynamic area as described in the first and the second exemplary embodiments.

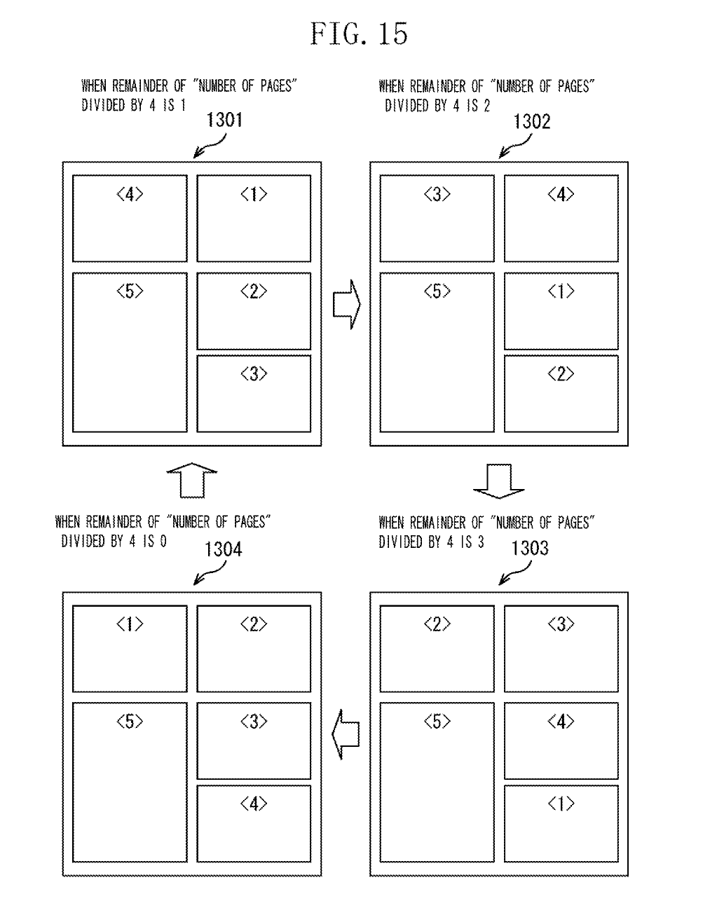

FIG. 15 illustrates examples of a layout change of the first field 1102 through the fourth field 1105 within the group 1107 according to the condition set via the dialog box 1201. In FIG. 15, since the number of fields to be rotated is four, four layouts exist including the basic layout.

In FIG. 15, a field layout 1301 indicates a state in which a remainder of the number of pages divided by 4 is “1”. More specifically, the field layout 1301 is a layout when the first field 1102 through the fourth field 1105 move one field position forward in the clockwise direction compared to the basic layout illustrated in FIG. 13A.

A field layout 1302 indicates a state in which a remainder of the number of pages divided by 4 is “2”. More specifically, the field layout 1302 is a layout when the first field 1102 through the fourth field 1105 move two field positions forward in the clockwise direction compared to the basic layout illustrated in FIG. 13A.

Similarly, a field layout 1303 indicates a state in which a remainder of the number of pages divided by 4 is “3”. More specifically, the field layout 1303 is a layout when the first field 1102 through the fourth field 1105 move three field positions forward in the clockwise direction compared to the basic layout illustrated in FIG. 13A. Further, a field layout 1304 indicates a state in which a remainder of the number of pages divided by 4 is “0”. The field layout 1304 is the same as the basic layout illustrated in FIG. 13A.

It is to be noted that since the operation of the client PC 111-113 for outputting data for form printing can be described by replacing a “dynamic area” in FIG. 8 with a “group”, a detailed description thereof will be omitted.

As described above, according to the third exemplary embodiment, a plurality of fields defined in a form template can be grouped and, further, a layout changing method for fields within a group and a condition of the layout changing method can be set via the dialog box 1201. In this way, a field to be changed can be selected without regard to an area of the form template. Thus, in addition to the advantage in the first exemplary embodiment, the third exemplary embodiment provides flexible and easier field layout change.

As with the second exemplary embodiment, by grouping a plurality of fields including a plurality of previously-grouped fields, the plurality of groups and fields 802-804 in such plurality of groups can be organized in a hierarchical manner. By managing a plurality of groups in a hierarchical manner, a field layout can be changed more finely according to the third embodiment as with the second exemplary embodiment.

### Fourth Exemplary Embodiment

Next, a fourth exemplary embodiment of the present invention will be described. In the first through the third exemplary embodiments, a layout changing method and an operating condition of the layout changing method are set collectively for a plurality of fields via the dialog box 401 or 1201. On the other hand, according to the fourth exemplary embodiment, a layout changing method and an operating condition of the layout changing method are set on a field-by-field basis. As described above, the first and the second exemplary embodiments and the fourth exemplary embodiment are similar except for processing of software for changing a field layout. Thus, a difference between the first and the second exemplary embodiments and the fourth exemplary embodiment lies only in the software processing for changing a field layout. Accordingly, in the description of the fourth exemplary embodiment, the same reference numerals as those illustrated in FIG. 1 through FIG. 15 are applied to the parts which are similar to those of the first through the third exemplary embodiments, and detailed descriptions thereof will be omitted.

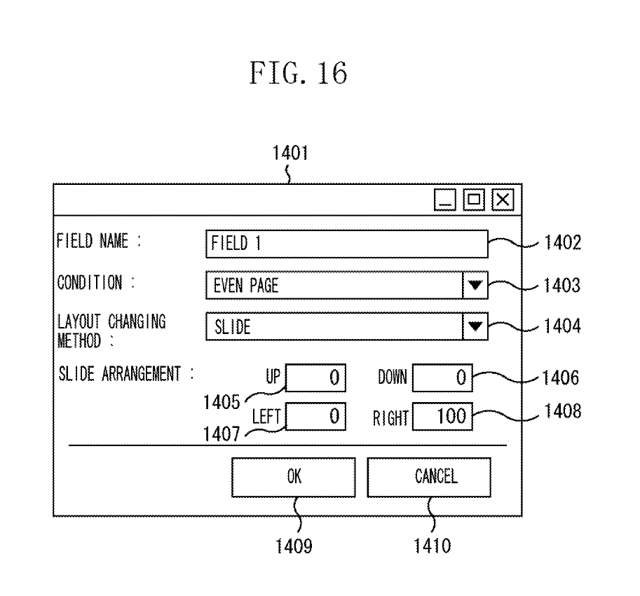

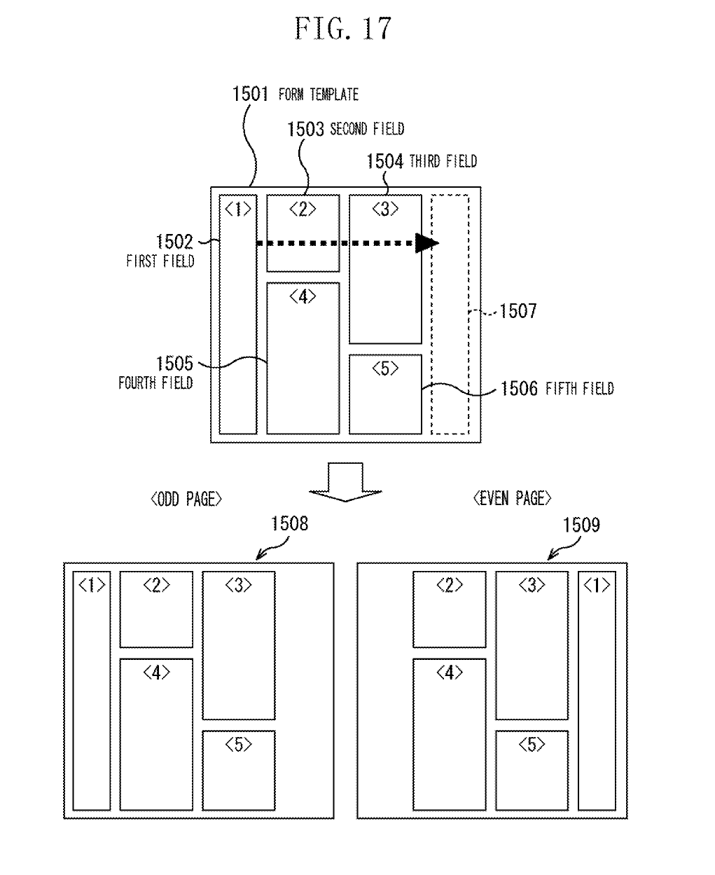

FIG. 16 illustrates an example of a dialog box adapted to set a layout changing method for a field defined in a form template and an operating condition of such layout changing method on a field-by-field basis. In FIG. 16, a control (text box) 1402 in a dialog box 1401 is used for setting a name of an object field. The user sets or changes the field name via the text box 1402. In FIG. 16, a name “FIELD 1” is set for a first field 1502 illustrated in FIG. 17. A control (list box) 1404 is used for selecting a layout changing method for an object field to be set. In FIG. 16, “SLIDE” is selected as a layout changing method for the first field 1502.

It is to be noted that various figural position changes, such as “FLIP VERTICAL”, “FLIP HORIZONTAL”, and “ROTATE” as well as “SLIDE” can be applied. In other words, a different layout changing method can be applied so long as the method changes the position of each field.

A control (list box) 1403 is adapted to set an operating condition of the layout changing method for an object field which is specified via the list box 1204. In FIG. 16, “EVEN PAGE” is selected via the list box 1403 as with the dialog box 401 illustrated in FIG. 5 in the first exemplary embodiment. Thus, the layout changing method specified via the list box 1404 is applied to an even page.

It is to be noted that, as with the first through the third exemplary embodiments, an operating condition of the layout changing method is defined by, for example, various conditions including a condition determined by page configuration, an arbitrary condition set at the time of outputting, and a condition determined by content of the form.

Controls (text boxes) 1405-1408 set a displacement of a field when the layout changing method is set to “SLIDE” in the list box 1404. More specifically, each of the text boxes 1405-1408 is used for setting a displacement of a field in an upward, a downward, a leftward, or a rightward direction, respectively.

In FIG. 16, the displacement in the upward, downward, and leftward directions are set to “0” while the displacement in the rightward direction is set to “100”. This indicates that the first field 1502 arranged on an even page slides 100 mm to the right. It is to be noted that if “SLIDE” is selected as the layout changing method, the text boxes 1405-1408 can also be displayed in the first through the third exemplary embodiments.

A button 1409 is adapted to apply the content of the dialog box 1401 and close the dialog box 1401, whereas a button 1410 is adapted to cancel and close the dialog box 1401.

FIG. 17 illustrates an example of a field layout which is changed according to the setting in the dialog box 1401 in FIG. 6. In a form template 1501, five fields or the first field 1502 through the fifth field 1506 are defined. Out of the five fields, the first field 1502 is a field set via the dialog box 1401. Thus, the first field 1502 that is arranged on an even page shifts 100 mm to the right. More specifically, the first field 1502 shifts to an area 1507, which is surrounded by a broken line in FIG. 17. The second field 1503 through the fifth field 1506 do not have the layout changing method applied.

When an odd page is output, the first field 1502 is not changed as illustrated in a field layout 1508. On the other hand, when an even page is output, the first field 1502 shifts 100 mm to the right as illustrated in a field layout 1509. In this way, a form implementing the field layout 1508 is output for an odd page, while a form implementing the field layout 1509 is output for an even page.

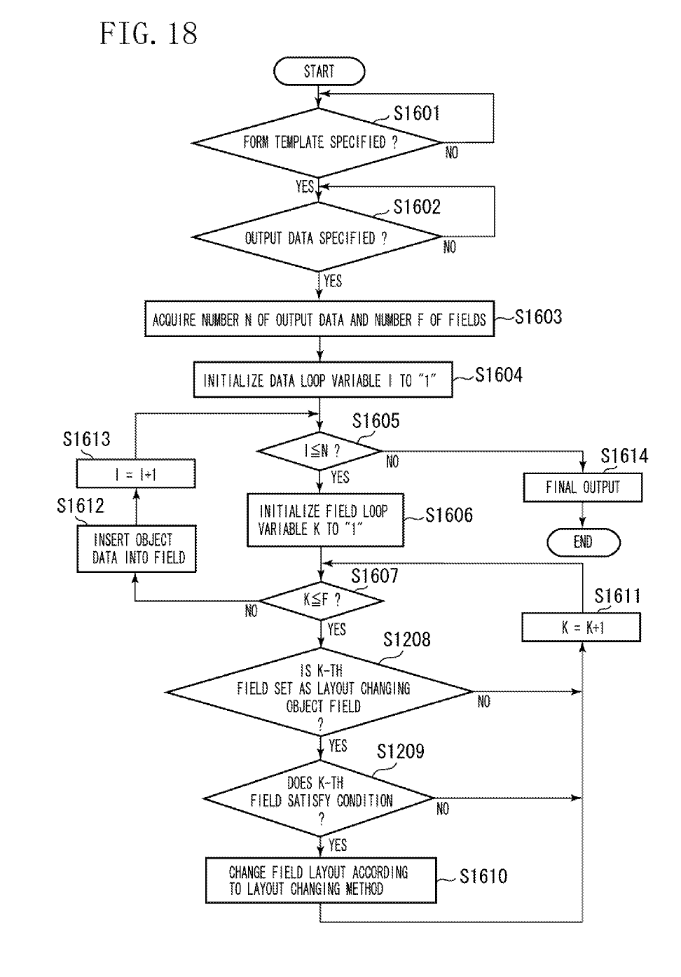

Next, an example of an operation of the client PC 111-113 for outputting data for form printing will be described with reference to the flowchart of FIG. 18. The process in FIG. 18 is executed after the setting in the dialog box 1401 illustrated in FIG. 16 is set.

Steps S1601 through S1605 are similar to steps S701 through S705 in FIG. 8 in the first exemplary embodiment. In steps S1601 and S1602, the client PC waits until a form template, which is used during outputting, and output data are specified. Then, in step S1603, the client PC acquires the number N of output data specified in step S1602 and the number F of fields defined in the form template specified in step S1601.

In step S1604, the client PC initializes a data loop variable I to “1”. The data loop variable I is used for processing all of the output data. Then, in step S1605, the client PC determines whether the number N of output data is equal to or greater than the data loop variable I. As a result of this determination, if the number N of output data is smaller than the data loop variable I (NO in step S1605), the process proceeds to step S1614. On the other hand, if the number N of output data is equal to or greater than the data loop variable I and when there is unprocessed output data (YES in step S1605), the process proceeds to step S1606.

In step S1606, the client PC initializes a field loop variable K to “1”. The field loop variable K is used for checking all of fields included in the form template. It is to be noted that a setting method for the field loop variable K is not limited and a common method can also be used.

Next, in step S1607, the client PC determines whether the number F of fields defined in the form template specified in step S1601 is equal to or greater than the field loop variable K. As a result of this determination, if the number F of fields is smaller than the field loop variable K (NO in step S1607), the process proceeds to step S1612. On the other hand, if the number F of fields is equal to or greater than the field loop variable K and when there is an unprocessed field (YES in step S1607), the process proceeds to step S1608.

In step S1608, the client PC determines whether an attribute for changing a layout (dynamic attribute) is set as an attribute for the K-th field based on, for example, the dialog box 1401. As a result of this determination, if an attribute for changing a layout (dynamic attribute) is not set as the attribute for the K-th field (NO in step S1608), the K-th field will not be a field whose layout is to be changed. Then, the process proceeds to step S1611. On the other hand, if the attribute for changing a layout is set as the attribute for the K-th field (YES in step S1608), the K-th field will be a field whose layout is to be changed. Then, the process proceeds to step S1609.

In step S1609, the client PC determines whether the K-th field satisfies an operating condition of the layout changing method set via the dialog box 1401. As a result of this determination, if the K-th field does not satisfy the operating condition (NO in step S1609), the process proceeds to step S1611. On the other hand, if the K-th field satisfies the operating condition (YES in step S1609), the process proceeds to step S1610.

In step S1610, the client PC changes the layout of a field for the I-th output data according to the layout changing method. Then, the process proceeds to step S1611.

In step S1611, the client PC adds “1” to the field loop variable K to process the next field. Then, the process returns to step S1607.

If the number F of fields defined in the form template is smaller than the field loop variable K and processing has been applied to all of the fields defined in the form template in step S1607 (NO in step S1607), the process proceeds to step S1612. In step S1612, the client PC inserts the I-th output data into a form template field whose layout is determined in steps S1606 through S1611.

In step S1613, the client PC adds “1” to the data loop variable I to process the next data. Then, the process returns to step S1605.

In step S1605, if the number N of output data is smaller than the data loop variable I and processing has been applied to all of output data (NO in step S1605), the process proceeds to step S1614. In step S1614, the client PC organizes forms which are generated for each output data to generate final output data for form printing, and outputs the generated data for form printing to the printer 115. It is to be noted that organizing forms which are generated for each output data to generate final output data for form printing can be accomplished by simply combining the forms generated for each output data. However, the method for organizing the forms is not limited, and different processing can be adopted.

As described above, according to the fourth exemplary embodiment, a layout changing method for a field and an operating condition of the layout changing method can be set on a filed-by-field basis. In this way, in addition to the advantage described in the first exemplary embodiment, field layout can be changed more flexibly, thus reducing constraint regarding changing of a field layout.

According to the fourth exemplary embodiment, the layout of a field area defined in a print form can be changed flexibly. A plurality of print forms having different layouts but with the same field number and content can be managed as one template.

### Other Exemplary Embodiments

In order to achieve the aforementioned exemplary embodiments by operating various types of devices, a software program code configured to provide the function of the present exemplary embodiment can be supplied to a computer in an apparatus or a system which is connected to such devices. Operating the devices according to a program stored in the computer (CPU or MPU) in the system or the apparatus can also be interpreted as an exemplary embodiment of the present invention.

Also, in this case, the software program code itself realizes the functions of the aforementioned exemplary embodiments. Also, the program code itself and a unit for providing the program code to a computer, and a storage medium adapted to store the program code embody the present invention. The storage medium for storing the program code includes a flexible disk, a hard disk, an optical disk, a magneto-optical disk, a CD-ROM, a magnetic tape, a non-volatile memory card, and a ROM.

When the computer runs the supplied program code, the functions of the aforementioned exemplary embodiment are realized. The program code, when it realizes the functions of the embodiment together with an operating system running on a computer or other application software, etc., are also included in an exemplary embodiment of the present invention.

Further, after the supplied program code is stored in a memory provided in a function expansion board of the computer, based on an instruction of the program code, the CPU of the function expansion board executes a part or all of the actual processing. A case where a function of the aforementioned exemplary embodiments is realized according to this processing is also included in an exemplary embodiment of the present invention. Also, after the supplied program code is stored in a memory provided in a function expansion unit connected to the computer, based on an instruction of the program code, the CPU of the function expansion unit executes a part or all of the actual processing. A case where a function of the aforementioned exemplary embodiments is realized according to this processing is also included in an exemplary embodiment of the present invention.

As described above, according to an exemplary embodiment, a condition concerning a setting for a layout change of at least one field area out of a plurality of field areas is received, and the layout of the field area is changed according to the received condition. Thus, the layout of a field area defined in a print form can be flexibly changed. Further, a plurality of print forms having the same number and content of field areas and having different layouts can be managed as one print form.

Further, according to an exemplary embodiment, a setting of a dynamic area including at least two field areas out of a plurality of field areas is received, and also a setting of a condition concerning the layout change of fields in the received dynamic area is received. The layout of field areas is changed according to the received condition. Thus, by specifying an area of a print form, a field area to be changed can be selected, and the layout of fields can be changed more easily.

Also, according to an exemplary embodiment, specification of at least two field areas out of a plurality of field areas are received, and the received at least two field areas are grouped. Then, a setting of a condition concerning a layout change of the grouped field areas is received. According to the received condition, the layout of field areas can be changed. Thus, a field area to be changed can be selected without regard to an area of a print form. In this way, the layout of fields can be changed more easily and flexibly.

Also, according to an exemplary embodiment, a setting of a previously received dynamic area (previously grouped field areas) and a setting of a dynamic area including a field area not included in the previously received dynamic area (a field area different from the previously grouped field areas) are received. Also, a condition concerning changing of a layout of a previously received dynamic area (previously grouped group) is received. According to the received condition, changing of the layout of field areas is performed. Thus, finer changing of the layout of field areas can be achieved compared to when a single dynamic area (group) is set.

Also, according to an exemplary embodiment, specification of one field area out of a plurality of field areas is received, and then a setting of a condition for a layout change of the received field area is received. According to the received condition, the layout of the field area can be changed. Accordingly, a layout change can be performed in units of field area, thus reducing constraint when changing the layout of a field area. Thus, the layout of the field area can be changed more flexibly.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-174459 filed Jun. 23, 2006, which is hereby incorporated by reference herein in its entirety.

What is claimed is:

1. An apparatus configured to generate print data based on a print form having a plurality of field areas defined therein into which data can be inserted and to output the print data to a printing apparatus, the apparatus comprising:
a first receiving unit configured to receive a setting of a condition concerning changing of a layout of at least one field area of the plurality of field areas defined in the print form;
a changing unit configured to change a layout of the at least one field area defined in the print form according to the condition received by the first receiving unit; and
a print data generating unit configured to generate print data based on the print form having the layout of the at least one field area changed by the changing unit.

2. The apparatus according to claim 1, further comprising a second receiving unit configured to receive a setting of a dynamic area including at least two field areas of the plurality of field areas defined in the print form,
wherein the first receiving unit receives a setting of a condition concerning changing of a layout of the field areas included in the dynamic area received by the second receiving unit.

3. The apparatus according to claim 2, further comprising:
a third receiving unit configured to receive a setting of at least one dynamic area previously received by the second receiving unit and a setting of a dynamic area including at least one field area not included in the dynamic area previously received by the second receiving unit; and
a first management unit configured to manage data of the dynamic area received by the third receiving unit and data of the dynamic area previously received by the second receiving unit based on a hierarchical structure,
wherein the first receiving unit further receives a condition concerning changing of a layout of the dynamic area previously received by the second receiving unit.

4. The apparatus according to claim 1, further comprising:
a fourth receiving unit configured to receive a specification of at least two field areas of the plurality of field areas; and
a first grouping unit configured to group the at least two field areas received by the fourth receiving unit,
wherein the first receiving unit receives a setting of a condition concerning changing of a layout of the field areas grouped by the first grouping unit.

5. The apparatus according to claim 4, further comprising:
a sixth receiving unit configured to receive a specification of the at least two field areas previously grouped by the first grouping unit and a specification of at least one field area different from the at least two field areas;
a second grouping unit configured to group the field areas received by the sixth receiving unit; and
a group management unit configured to manage data of the field areas grouped by the second grouping unit and data of the field areas previously grouped by the first grouping unit based on a hierarchical structure;
wherein the first receiving unit further receives a condition concerning changing of a layout of the field areas previously grouped by the first grouping unit.

6. The apparatus according to claim 1, further comprising a fifth receiving unit configured to receive a specification of one field area of the plurality of field areas,
wherein the first receiving unit receives a setting of a condition concerning changing of a layout of the field area received by the fifth receiving unit.

7. The apparatus according to claim 1, wherein the print data generating unit inserts data into the field area defined in the print form having the layout of the field area changed by the changing unit and generates print data based on the print form having the data inserted into the field area.

8. The apparatus according to claim 1, further comprising a condition determination unit configured to determine whether the field area defined in the print form satisfies the condition received by the first receiving unit,
wherein the changing unit changes a layout of the field area determined by the condition determination unit to satisfy the condition received by the first receiving unit.

9. The apparatus according to claim 1, wherein the first receiving unit receives a changing condition of the layout of the field area and an operating condition of the changing condition.

10. A method for generating print data based on a print form having a plurality of field areas defined therein into which data can be inserted and for outputting the print data to a printing apparatus, the method comprising:
receiving a setting of a condition for changing a layout of at least one data insertable field area of the plurality of data insertable field areas defined in the print form;
changing a layout of the at least one field area defined in the print form according to the received condition; and
generating print data based on the print form having the changed layout of the field area.

11. The method according to claim 10, further comprising:
receiving a setting of a dynamic area including at least two field areas of the plurality of field areas defined in the print form; and
receiving a setting of a condition concerning changing of a layout of the field areas included in the received dynamic area.

12. The method according to claim 11, further comprising:
receiving a setting of at least one dynamic area previously received and a setting of a dynamic area including at least one field area not included in the dynamic area previously received;
managing data of the received dynamic area and data of the dynamic area previously received based on a hierarchical structure, and
receiving a condition concerning changing of a layout of the dynamic area previously received.

13. The method according to claim 10, further comprising:
receiving a specification of at least two field areas of the plurality of field areas;
grouping the received at least two field areas; and
receiving a setting of a condition concerning changing of a layout of the grouped field areas.

14. The method according to claim 13, further comprising:
receiving a specification of the at least two field areas previously grouped and a specification of at least one field area different from the at least two field areas;
grouping the received field areas;
managing data of the grouped field areas and data of the field areas previously grouped using a hierarchical structure; and
receiving a condition concerning changing of a layout of the field areas previously grouped.

15. The method according to claim 10, further comprising:
receiving a specification of one field area of the plurality of field areas; and
receiving a setting of a condition concerning changing of a layout of the received field area.

16. The method according to claim 10, further comprising:
inserting data into the field area defined in the print form having the layout of the field area changed; and
generating print data based on the print form having the data inserted into the field area.

17. The method according to claim 10, further comprising:
determining whether the field area defined in the print form satisfies the received condition; and
changing a layout of the field area determined to satisfy the received condition.

18. The method according to claim 10, further comprising receiving a changing condition of the layout of the field area and an operating condition of the changing condition.

19. A computer-executable program stored on a computer-readable medium, including instructions, which when executed by an apparatus, causes the apparatus to perform operations comprising:
receiving a setting of a condition for changing a layout of at least one data insertable field area of a plurality of data insertable field areas defined in a print form;
changing a layout of the at least one data insertable field area defined in the print form according to the received condition; and
generating print data based on the print form having the changed layout of the field area.
